(19) United States
(12) Patent Application Publication
(10) Pub. No.: US 2012/0116741 A1
(43) Pub. Date: May 10, 2012

(54) SYSTEMS AND METHODS OF CONSTRUCTING A PATIENT SPECIFIC NEURAL ELECTRICAL STIMULATION MODEL

(75) Inventors: Charles Tak Ming Choi, Hsinchu City (TW); Yi-Hsuan Lee, Hsinchu City (TW)

(73) Assignee: NATIONAL CHIAO TUNG UNIVERSITY, Hsinchu City (TW)

(21) Appl. No.: 13/110,771

(22) Filed: May 18, 2011

(30) Foreign Application Priority Data
Nov. 10, 2010 (TW) 099138620

(51) Int. Cl. G06G 7/60

(52) U.S. Cl. 703/11

(57) ABSTRACT

A system and a method of constructing a personalized or patient specific neural stimulation model. The method includes measuring an electro-physiology signal of an individual and establishing a personalized or patient specific neural stimulation model that has a preset model parameter and generates a human physiology parameter according to the model parameters; and analyzing the human physiology parameters and regulating the model parameters according to a parameter-optimizing algorithm, such that the human physiology parameters outputted by the personalized or patient specific neural stimulation model matches the measured electro-physiology signal.

### BACKGROUND OF THE INVENTION

1. Field of the Invention

This invention relates to systems and methods of constructing a neural electrical stimulation model, and more particularly, to a system and a method of constructing a patient specific neural electrical stimulation model of the human anatomy, electrodes, and nerves.

2. Description of Related Art

Modern medical technology prospers and neural electrical stimulation systems have been widely used, which include cochlear implants, deep brain stimulations, spinal cord stimulations, vagus nerve stimulations, retinal prostheses, heart pace makers and the like. These systems achieve the purpose of stimulating nerves or changing the mode of nerve discharge or response via implanted micro electrodes that deliver micro currents. However, the performance of the implanted nerve stimulation system is difficult to predict since no single device can fit all and no implantee are alike. Also, there is a need to find a suitable set of stimulation parameters for each neural stimulation device, which can take many months to identify before an “optimal” or near “optimal” set of stimulation parameters is found for a particular patient. For example, there are more than 12,000 possible combinations of stimulation parameters (e.g. stimulation voltage, pulse width, and stimulation rate) for a typical deep brain stimulator (DBS) device, but a DBS clinician typically has only three to six months (which translate to 10 to 20 sessions) to identify an “optimal” set of stimulation parameters for that particular patient. Therefore, there is a need to construct a neural electrical stimulation response model which closely resembles the neural electrical stimulation response or physiological response of a patient. If such model can be found, it is possible to search the model to identify a truly optimal set of stimulation parameters for the electrical neural stimulation device for a particular patient in a short period of time. For example, we can quickly narrow the possible combinations of parameters from more than 12,000 to less than 50, which is easily manageable within a few programming sessions. As illustrated in FIG. 1, a flow chart is illustrated to construct a neural electrical stimulation model according to the prior art. These neural electrical stimulation systems have implanted electrodes which may assist to measure a physiological signal used to construct a model so as to simulate the response of the neural electrical stimulation system. In step S11, a general model of the neural electrical stimulation system is constructed by a finite element method or other numerical methods. In step S12, a preset value of a model parameter of the general model of this neural electrical stimulation system is set. In step S13, a neural electrical stimulation response of an individual is simulated by using the neural electrical stimulation model having the preset value of the model parameter.

Please refer to FIG. 2, which illustrates an anatomical diagram of a human ear 2. The human ear 2 has a cochlea responsible for collecting sound which may deliver the sound to an external acoustic meatus 21. The external acoustic meatus 21 has a resonance structure in which the sound may be rendered to resonate, and then delivered to a middle ear eardrum 22 full of air. An auditory ossicle is connected above the middle ear eardrum 22. A signal is amplified by the auditory ossicle and delivered to an oval window of an inner ear 23. The inner ear 23 is filled with liquid while the oval window resonates to facilitate the liquid to flow so as to further stimulate hair cells 24 such that the hair cells 24 bend and then deliver electric charge to the auditory nerve fibers. Next, auditory nerve signals from both ears are delivered to the auditory cortex or center of the brain to generate auditory perception. However, if the hair cell 24 is damaged, a cochlear implant system is needed. Generally, the steps and methods to make a cochlear implant system work involves converting the surrounding sound to generate auditory perception in a cochlear implant user are: sound passes through a microphone, a speech processor, a transmitter (placed outside the skull), a receiver (implanted inside the skull), and then enters the cochlea to reach the auditory nerve fibers. The function of a cochlear implant system involves using implant electrodes in the cochlea to substitute the hair cells with the micro current to stimulate the remaining auditory nerves so as to achieve the purpose of auditory perception. Therefore, according to the previous principle, for achieving the purpose of simulation and analysis, the neural electrical stimulation model illustrated in FIGS. 1 and 2 may be constructed to simulate the neural electrical stimulation response of the cochlear implant system.

However, this neural electrical stimulation system is a general model not capable of accurately representing the neural electrical stimulation responses quantitatively of different human individuals.

Hence, it is important to construct a patient specific or personalized neural electrical stimulation model which may improve shortcomings of prior arts.

### SUMMARY OF THE INVENTION

In view of the above-mentioned problems of the prior art, it is a primary objective of the present invention to provide a method of constructing a patient specific or personalized neural electrical stimulation model, the method comprising the steps of: (1) measuring an electro-physiological signal of an individual and constructing the patient specific or personalized neural electrical stimulation model that has a preset model parameter and generates a human physiological parameter according to the model parameter; and (2) analyzing the human physiological parameter generated and regulating the model parameter according to a parameter-optimizing algorithm such that the human physiological parameter outputted by the patient specific or personalized neural electrical stimulation model matches the measured electro-physiological signal.

The present invention further provides a system of constructing the patient specific or personalized neural electrical stimulation model, comprising: a signal-measuring module for measuring the electro-physiological signal of the individual; a model generator for generating the patient specific or personalized neural electrical stimulation model having the preset model parameter such that the patient specific or personalized neural electrical stimulation model generates the human physiology parameters according to the model parameters; an analysis module for analyzing and comparing the human physiological parameters outputted by the patient specific or personalized neural electrical stimulation model and the electro-physiological signal measured by the signal-measuring module; and an optimization module for regulating the model parameter according to the parameter-optimizing algorithm such that the human physiological parameter outputted by the patient specific or personalized neural electrical stimulation model according to the regulated model parameters matches the measured electro-physiological signals.

### BRIEF DESCRIPTION OF DRAWINGS

FIG. 1 illustrates a flow chart of constructing a neural electrical stimulation model according to the prior art;

FIG. 2 illustrates an anatomical diagram of a human ear;

FIG. 3 illustrates a flow chart of a method of constructing a patient specific or personalized neural electrical stimulation model in accordance with the present invention;

FIG. 4 illustrates a schematic equivalent circuit diagram of an electrode array of an cochlear implant;

FIG. 5A illustrates a transimpedance matrix of a personal electro-physiological signal measured by the cochlear implant in accordance with the present invention;

FIG. 5B illustrates the transimpedance matrix generated by optimizing a model parameter of the patient specific or personalized neural electrical stimulation model according to a genetic algorithm in accordance with the present invention; and

FIG. 6 illustrates a functional block diagram of a system of constructing the patient specific or personalized neural electrical stimulation model in accordance with the present invention; and

FIG. 7 illustrates a schematic measurement diagram of a deep brain stimulation system in accordance with the present invention.

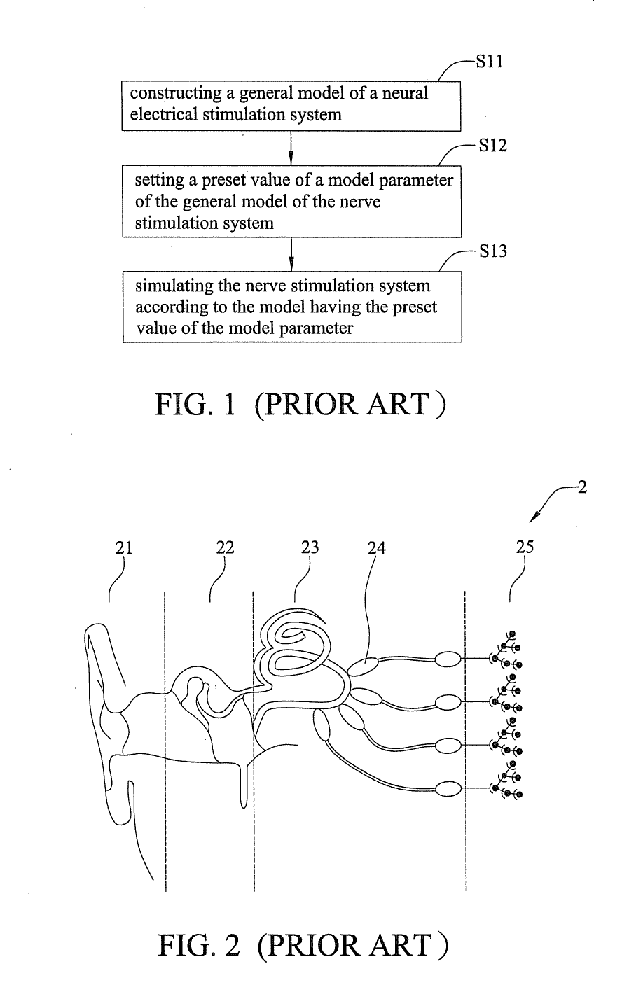

### DETAILED DESCRIPTION OF PREFERRED EMBODIMENTS

The following illustrative embodiments are provided to illustrate the disclosure of the present invention, these and other advantages and effects can be apparently understood by persons skilled in the art after reading the disclosure of this specification. The present invention can also be performed or applied by other different embodiments.

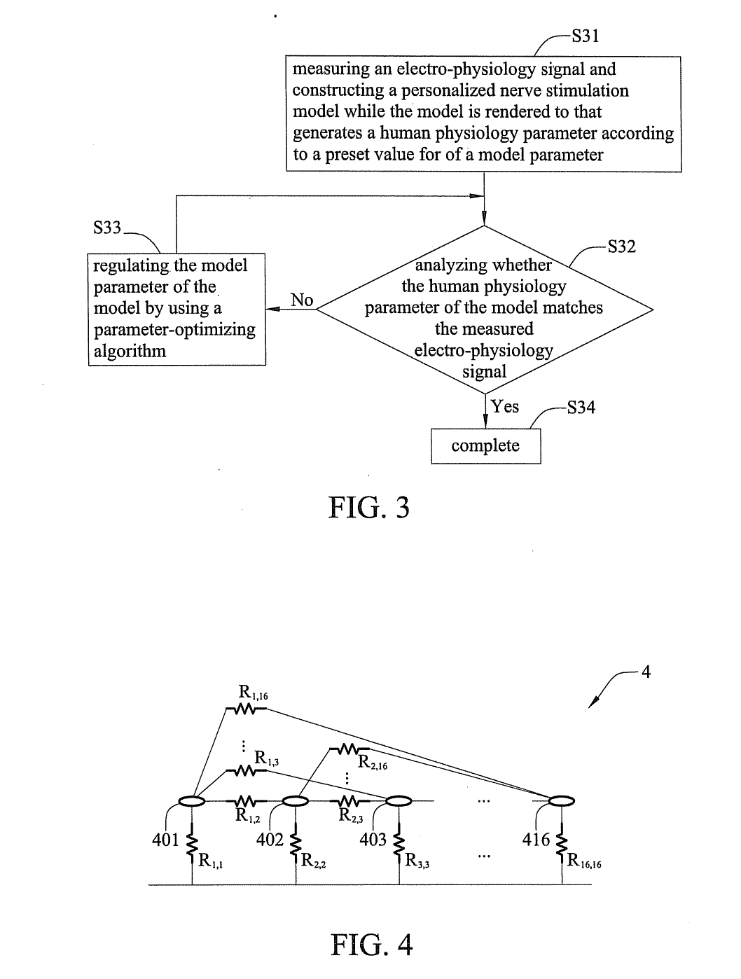

Please refer to FIG. 3, which illustrates a flow chart of a method of constructing a patient specific or personalized neural electrical stimulation model in accordance with the present invention. First, electrodes for measuring an electro-physiological signal are implanted into a particular location of a human body. In step S31, a current is applied on an electrode so as to generate a stimulation response, and another electrode is used to measure an electro-physiological signal of the location. At the same time, the patient specific or personalized neural electrical stimulation model is constructed, and the model is rendered to generate a human physiological parameter according to a preset value for a model parameter. In step S32, whether the human physiological parameter of the model matches the measured electro-physiological signal is analyzed. If the human physiological parameter of the model do not match the measured electro-physiological signal, the method proceeds to step S33. In step S33, the model parameter is regulated according to a parameter-optimizing algorithm (that is, the preset value for the model parameter in step S31 is changed) such that the human physiological parameter outputted by the patient specific or personalized neural electrical stimulation model matches the measured electro-physiological parameter. In step S34, if the human physiological parameter of the model do match the measured electro-physiological signal, the generated neural electrical stimulation model may be confirmed to be able to specifically simulate a physiological response of an individual so as to benefit research and analysis of patient specific or personalized neural electrical stimulation system.

In the previously described step S31, the electro-physiology signal of the individual is measured by a particular test method. In step S32, the particular test method is applied to the patient specific or personalized neural electrical stimulation model such that the model generates the human physiological parameter according to the model parameter and judges whether the human physiological parameter matches the measured electro-physiological signal. In an embodiment of the present invention, the electro-physiological signal is a voltage physiological signal, a current physiological signal, an electrode impedance signal, a transimpedance signal, an action potential signal, an EMG (Electromyogram) signal, an ECG (Electrocardiogram) signal, an EKG (Electrocardiogram) signal, an EEG (Electroencephalogram) signal, a MEG (Magnetoencephalography) signal or an EOG (Electro-oculogram) signal. If the human physiological parameter matches the measured electro-physiological signal , a construction procedure of the model is complete; if the human physiological parameter does not match the measured electro-physiological signal, the human physiological parameter of the model and the measured electro-physiological signal are continuously analyzed so as to regulate the model parameter via the parameter-optimizing algorithm.

In an embodiment, the previously described voltage physiological signal, current physiological signal, electrode impedance signal or action potential signal are measured via the electrodes implanted into the particular location of the human body. Additionally, the model parameter may be the conductivity or resistivity of the patient specific or personalized neural electrical stimulation model, and the human physiology parameter is a voltage simulation signal, a current simulation signal, an impedance simulation signal, an action potential simulation signal, an EMG (Electromyogram) signal, an ECG (Electrocardiogram) signal, an EKG (Electrocardiogram) signal, an EEG (Electroencephalogram) signal, a MEG (Magnetoencephalography) signal or an EOG (Electro-oculogram) signal generated by the patient specific or personalized neural electrical stimulation model according to the conductivity or resistivity.

In another embodiment, the patient specific or personalized neural electrical stimulation model is constructed according to a finite element method or other numerical methods, such as finite element time domain, finite difference method, finite difference time domain, finite volume method, finite volume time domain, transmission line matrix method, boundary element method, moment methods, or integral equation method.

In further embodiment, the patient specific or personalized neural electrical stimulation model may be a cochlear implant model, a deep brain stimulation model, a spinal cord stimulation model, a vagus nerve stimulation model, a retinal prosthesis model or a heart pace maker model.

As illustrated in FIG. 4, an example is illustrated for constructing the nerve stimulation model applicable to an cochlear implant in accordance with the present invention. This embodiment illustrates an schematic equivalent circuit diagram of an electrode array 4 of a cochlear implant system. In the cochlear implant system, 16 electrodes 401˜416 for measuring the voltage physiological signal have to be implanted into a cochlea so as to construct the electrode array 4 (not all the 16 electrodes are shown in FIG. 4), wherein an impedance R₁₂ is formed between the electrode 401 and the electrode 402. A measurement method is to measure voltage physiological signals V₁-V₁₆ and obtain transimpedances Z_{1,1}-Z_{1,16} of the cochlear implant system by dividing V₁-V₁₆ by I₁ after applying the current I₁ to the electrode 401. Next, the above step is iterated to apply currents I₂-I₁₆ to the electrodes 401-416 so as to obtain the rest transimpedances Z_{2,1}-Z_{16,16} such that a transimpedance matrix for Z₁₆ₓ₁₆ is formed. Accordingly, if a patient specific or personalized neural electrical stimulation model for the cochlear implant is to be constructed, the model parameter of the patient specific or personalized neural electrical stimulation model in the previously described step S31 of FIG. 3 may be optimized by the parameter-optimizing algorithm such that an output of the constructed patient specific or personalized neural electrical stimulation model for the cochlear implant is extremely similar to an electro-physiological signal measured in the electrodes of the personalized cochlear implant (i.e., the transimpedances measured in an individual ear via the electrode array 4). The previously described parameter-optimizing algorithm may be exemplarily a genetic algorithm or other kind of intelligent algorithm (e.g., evolutionary algorithm, swarm based optimization algorithms, simulated annealing, Monte Carlo based algorithms, hill climbing optimization algorithm, Tabu search, combinatorial algorithms, linear programming, nonlinear programming, gradient based optimization method, Hessian based optimization method, or function based optimization method) which may obtain a global optimum solution. However, the present invention is not restrictive of electro-physiological signal type while physiological characteristics or nerve responses which could be measured in a general individual all may be applicable to the present invention so as to construct the personalized nerve stimulation model. Moreover, the present invention may regulate the model parameter of the same nerve stimulation model by using different electro-physiological signals. For example, the model parameter may be regulated by using the voltage physiological signal and the action potential signal simultaneously such that the finally generated neural electrical stimulation model has the characteristics of voltage responses and nerve action responses.

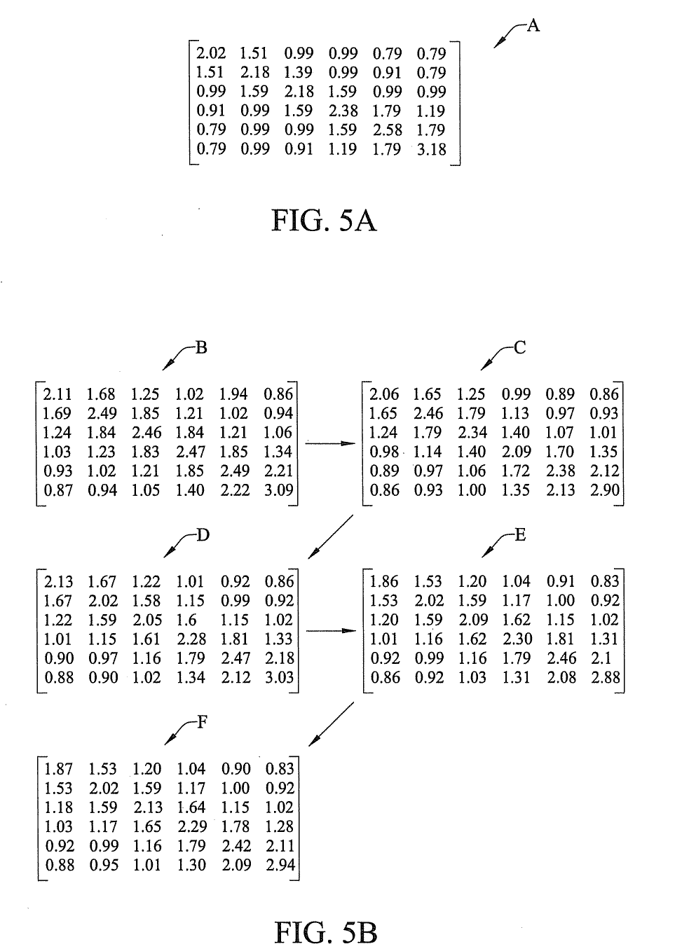

Please refer to FIGS. 5A and 5B. FIG. 5A illustrates a transimpedance matrix A measured and calculated according to the previously described electrode array 4 in FIG. 4 in accordance with the present invention. In FIG. 5B, the model parameter (for instance, the conductivity) of the patient specific or personalized neural electrical stimulation model is regulated upon a first iteration of the genetic algorithm such that the patient specific or personalized neural electrical stimulation model generates a new transimpedance matrix B according to the regulated model parameter. Then, the model parameter is regulated upon a fourth iteration, an eighth iteration, a twelfth iteration and a sixteenth iteration of the genetic algorithm so as to generate transimpedance matrixes B, C, D, E and F. It may be shown by the calculation procedure of genetic algorithm, the model parameter is performed with optimization regulation upon many times of iterations such that the transimpedance matrix outputted by the patient specific or personalized neural electrical stimulation model will approach a transimpedance matrix as measured by an individual human test subject. In the case of the electrode impedance signal, the difference value between a simulated electrode impedance signal outputted by the patient specific or personalized neural electrical stimulation model and an electrode impedance signal actually measured in the individual human test subject is smaller and smaller after many iterations of using genetic algorithm to optimize and match the model parameters, thereby confirming that the finally generated neural electrical stimulation model is a patient specific or personalized physiological response simulation system. A research team may treat the output of the model as the actual neural response signal from a particular human subject instead of having to measure from that particular human test subject physically. This model is beneficial because often patients or human test subjects are not available for measurements and test trials in an extended period of time, e.g. typical a DBS patient will meet a clinician for DBS programming only for a few hours for every clinic visit. This patient specific neural electrical stimulation model allows us to access the patient or human subject data extensively so that it will be possible to identify the “optimal” set of electrical stimulation parameters for the patient or human test subject in a shorter period of time.

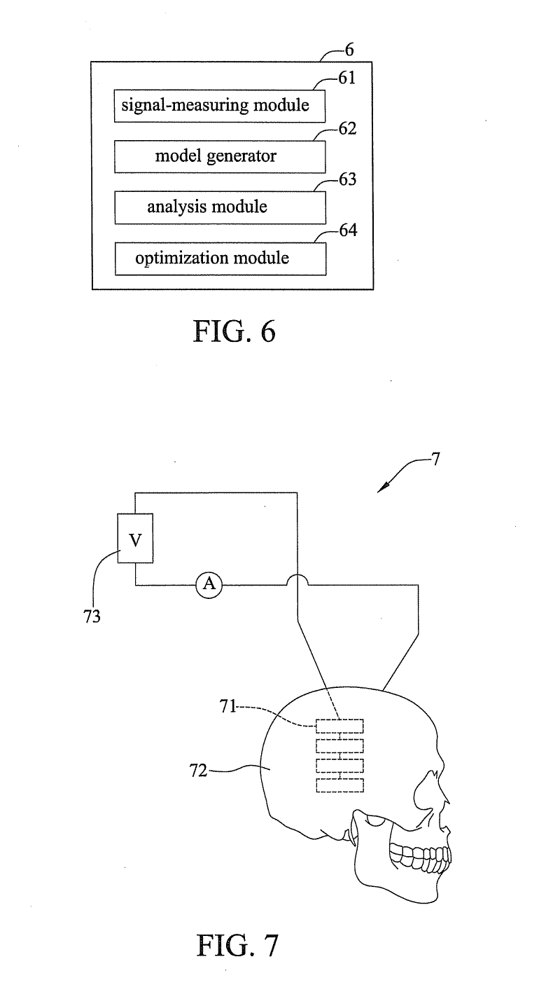

Please refer to FIG. 6, which illustrates a functional block diagram of a system for constructing the patient specific or personalized neural electrical stimulation model in accordance with the present invention. As illustrated, the system 6 for the patient specific or personalized neural electrical stimulation model comprises a signal-measuring module 61 for measuring the electro-physiological signal of the individual, a model generator 62 for generating the patient specific or personalized neural electrical stimulation model having the preset model parameter such that the patient specific or personalized neural electrical stimulation model generates the human physiological parameter according to the model parameter, an analysis module 63 for analyzing and comparing the human physiological parameter outputted by the patient specific or personalized neural electrical stimulation model with the electro-physiological signal measured by the signal-measuring module 61, and an optimization module 64 for regulating the model parameter by using the parameter-optimizing algorithm such that the patient specific or personalized neural electrical stimulation model matches the measured electro-physiological signal according to the human physiological parameter outputted by the regulated model parameter. In an embodiment, the signal-measuring module 61 further comprises the electrodes disposed in the particular location of the human body such that the electrodes measure the electro-physiological signal of the individual. The electro-physiological signal includes the voltage physiology signal, the current physiology signal or the electrode impedance signal. In an embodiment, at least one of the previously described plurality of electrodes may be used to be a sensor for capturing action potential signals, such as evoked compound action potentials, measured in the other electrodes.

In another illustrative embodiment of the present invention, it may measure a necessarily inputted current value of each electrode of the cochlear implant system rendering a threshold level (T level) and a most comfortable or maximum level (M level) of the magnitude of a current value decibel just heard by a user, and a ratio (T/M level) of these values is used to be the electro-physiological signal, thereby optimizing the model parameter to the nerve stimulation model.

FIG. 7 illustrates a schematic measurement diagram of a deep brain stimulation system 7. The principle of the system 7 is described previously. An electrode 71 is disposed inside a skull 72, a current is applied to the electrode 71, and a potential on a voltmeter 73 is measured so as to calculate the electro-physiological signal of the skull while regulating the preset model parameter of the deep brain stimulation model according to the parameter-optimizing algorithm such that the human physiological parameter (also called as the simulated electro-physiological signal) outputted by the deep brain stimulation model matches the measured electro-physiological signal so as to construct a personalized deep brain stimulation model.

In conclusion, the system and method of constructing the patient specific or personalized neural electrical stimulation model may obtain a patient specific or personalized neural electrical stimulation system model matching the actual measured electro-physiological signal upon the parameter-optimizing algorithm so as to more accurately simulate the response of the nerve stimulation system.

The foregoing implementation aspects only exemplarily illustrate the principles and effects of the present invention and are not restrictive of the present invention. Persons skilled in the art all may perform modifications and variations of the above implementation aspects without departing from the spirit and scope of the present invention. Hence, the scope of the present invention should fall within the appended claims.

What is claimed is:

1. A method of constructing a personalized or patient specific neural electrical stimulation model, the method comprising the steps of:
(1) measuring an electro-physiological signal of an individual and constructing the personalized or patient specific neural electrical stimulation model that has a preset model parameter and generates a human physiological parameter according to the model parameter; and
(2) analyzing the human physiological parameter and regulating the model parameter according to a parameter-optimizing algorithm, such that the human physiological parameter outputted by the personalized or patient specific neural electrical stimulation model matches the measured electro-physiological signal.

2. The method of claim 1, wherein step (1) further comprises measuring the electro-physiological signal of the individual by a particular test method, and wherein step (2) further comprises:
(2-1) applying the particular test method to the personalized or patient specific neural electrical stimulation model such that the personalized or patient specific neural electrical stimulation model generates the human physiological parameter according to the model parameter and judges whether the human physiological parameter matches the measured electro-physiological signal; and
(2-2) finishing a construction procedure of the personalized or patient specific neural electrical stimulation model if the human physiological parameter matches the measured electro-physiological signal, or regulating the model parameter of the personalized or patient specific neural electrical stimulation model according to the parameter-optimizing algorithm.

3. The method of claim 1, wherein the personalized or patient specific neural electrical stimulation model is a cochlear implant model, a deep brain stimulation model, a spinal cord stimulation model, a vagus nerve stimulation model, a retinal prosthesis model or a heart pace maker model.

4. The method of claim 1, wherein the electro-physiological signal is a voltage physiological signal, a current physiological signal, an electrode impedance signal, a transimpedance signal, an action potential signal, an EMG (Electromyogram) signal, an ECG (Electrocardiogram) signal, an EKG (Electrokardiogram) signal, an EEG (Electroencephalogram) signal, a MEG (Magnetoencephalography) signal or an EOG (Electro-oculogram) signal.

5. The method of claim 4, wherein the voltage physiological signal, the current physiological signal, the electrode impedance signal, the transimpedance signal, the action potential signal, the EMG (Electromyogram) signal, the ECG (Electrocardiogram) signal, the EKG (Electrocardiogram) signal, the EEG (Electroencephalogram) signal, the MEG (Magnetoencephalography) signal or the EOG (Electro-oculogram) signal are measured via electrodes implanted into a particular location of a human body.

6. The method of claim 1, wherein the model parameter is a conductivity or resistivity of the personalized or patient specific neural electrical stimulation model, and the human physiological parameter is a voltage simulation signal, a current simulation signal, an impedance simulation signal, a transimpedance simulation signal, an action potential simulation signal, an EMG (Electromyogram) simulation signal, an ECG (Electrocardiogram) simulation signal, an EKG (Electrocardiogram) simulation signal, an EEG (Electroencephalogram) simulation signal, a MEG (Magnetoencephalography) simulation signal or an EOG (Electro-oculogram) simulation signal generated by the personalized or patient specific neural electrical stimulation model according to the conductivity or resistivity.

7. The method of claim 1, wherein the personalized or patient specific neural electrical stimulation model is constructed according to finite element method, finite element time domain, finite difference method, finite difference time domain, finite volume method, finite volume time domain, transmission line matrix method, boundary element method, moment methods, or integral equation method.

8. The method of claim 1, wherein the parameter-optimizing algorithm is genetic algorithm, evolutionary algorithms, swarm based optimization algorithms, simulated annealing, Monte Carlo based algorithms, hill climbing optimization algorithm, Tabu search, combinatorial algorithms, linear programming, nonlinear programming, gradient based optimization method, Hessian based optimization method, or function based optimization method.

9. A system of constructing a personalized or patient specific neural electrical stimulation model, comprising:
a signal-measuring module for measuring an electro-physiological signal of an individual;
a model generator for generating the personalized or patient specific neural electrical stimulation model having a preset model parameter such that the personalized or patient neural electrical stimulation model generates a human physiological parameter according to the model parameter;
an analysis module for analyzing and comparing the human physiological parameter outputted by the personalized or patient specific neural electrical stimulation model and the electro-physiological signal measured by the signal-measuring module; and
an optimization module for regulating the model parameter according to a parameter-optimizing algorithm such that the human physiological parameter outputted by the personalized or patient specific neural electrical stimulation model according to the regulated model parameter matches the measured electro-physiological signal.

10. The system of claim 9, wherein the model generator generates a cochlear implant model, a deep brain stimulation model, a spinal cord stimulation model, a vagus nerve stimulation model, a retinal prosthesis model or a heart pace maker model.

11. The system of claim 9, wherein the signal-measuring module further comprises a plurality of electrodes implanted into a particular location of a human body so as to measure the electro-physiological signal of the individual by the electrodes.

12. The system of claim 11, wherein at least one of the electrodes is a sensor for capturing action potential signals, voltage physiological signals, current physiological signals, electrode impedance signals, transimpedance signals, EMG (Electromyogram) signals, ECG (Electrocardiogram) signals, EKG (Electrokardiogram) signals, EEG (Electroencephalogram) signals, MEG (Magnetoencephalography) signals, or EOG (Electro-oculogram) signals measured in the other electrodes.
